(19) United States
(12) Patent Application Publication
(10) Pub. No.: US 2006/0032143 A1
(43) Pub. Date: Feb. 16, 2006

(54) Window operator handle

(76) Inventor: Christopher Paul Johnson, Wellington (NZ)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/193,236

(22) Filed: Jul. 28, 2005

(30) Foreign Application Priority Data
Jul. 28, 2004 (NZ) 533760

(51) Int. Cl. E05F 11/24

(52) U.S. Cl. 49/341

(57) ABSTRACT

A handle for a window operator. The handle (10) is formed by a lever handle rotatably coupled to a mounting (12) which is pivotally mountable by pivot axles (22). A spigot mount (15) of the handle (10) is hingedly connected to a drive shaft (18) which is engageable with the drive mechanism of the operator. Clearances (16) and (23) of the spigot mount (15) and mounting (12) respectively can be aligned at a certain angular position of the lever handle (11) relative to the mounting (12) to enable the handle (11) and mounting (12) to be pivotally moved about the axis of axles (22). A latch operating member (29) can be coupled to the mounting (12) so that as the mounting (12) is pivotally moved about the axis of axles (22) the latch operating member can be moved to operate a window latch.

### BACKGROUND TO THE INVENTION

This invention relates to a handle for a window operator.

Window operators for control of the opening and closing of a window sash relative to a window frame are known. Conventionally the operator will incorporate a handle accessible from within the dwelling and to which a winding action can be applied. A mechanism within the operator imparts a force to the window sash to move the sash relative to the window frame. An example of such an operator can be found in U.S. Pat. No. 5,937,582.

It is known that the internal winder handle can be folded into a compacted position when not in use to thereby remove the projecting nature of the handle and also improve the aesthetic appeal of the operator. Examples of foldable handles for operators can be found in U.S. Pat. No. 6,450,063, U.S. Pat. No. 6,640,389, U.S. Pat. No. 551,316, U.S. Pat. No. 4,937,973, U.S. Pat. No. D451,781, U.S. Pat. No. D450,237, U.S. Pat. No. D497,304 and U.S. Pat. No. D375,445.

It is also known in the art to provide a window operator, which not only opens and closes the sash relative to the window frame, but also can control a multi-point locking mechanism e.g. U.S. Pat. No. 4,497,135. As a consequence, the sash can be moved by the operator into its closed position whereupon continued operation of the operator enables the multi-point mechanism to operate and thereby lock the window. Likewise, at opening the initial operation of the operator releases the multi-point locking mechanism so that continued operation of the operator is able to move the sash to an open position.

Window operators of this type are for example disclosed in our New Zealand patent specifications 336579 and 515949.

Such window operators suffer from the drawback that the motion changes from window closing to window locking at a fixed point, such that if wear occurs the locking can start with the window still open, with no way to compensate for this.

### SUMMARY OF THE INVENTION

An object of the present invention is to provide a handle for a window operator whereby the handle can drive a multi-point locking system independently from the closing motion.

Broadly according to one aspect of the invention there is provided a handle for a window operator, the handle including a lever handle, a mounting to which the lever handle is rotatably coupled, the mounting being mountable about a pivot axis, a drive element to which the lever handle is hingedly coupled, each of the lever handle and the mounting having a clearance such that the lever handle can be rotated to a position where the lever handle clearance aligns with the clearance of the mounting to thereby permit the mounting and lever handle to pivotally move relative to the drive element, the mounting including coupling means for the coupling of a part of a latching mechanism such that said part of the latching mechanism is movable in response to the pivotal movement of the lever handle and mounting.

Preferably the lever handle has a spigot mount and the mounting has a bore into which the spigot mount is rotatably located.

In the preferred form the lever handle clearance is formed by a longitudinally extending bore in the spigot mount, the slot opening through a distal end of the spigot mount and through which an end of the drive element extends into the slot.

Preferably the end of the drive element is pivotally coupled to the spigot mount inwardly of the distal end of the spigot mount.

Preferably the clearance in the mounting is a gap formed in the mounting and the mounting includes a pair of oppositely disposed outwardly projecting pivot elements.

The coupling means of the mounting can include a plurality of teeth or at least one pivot mount.

According to a second broad aspect of the invention there is provided a window operator including a drive mechanism, which, in use, is operable to cause a window to cause a window sash to move between open and closed positions, a drive element coupled to the drive mechanism, a mounting pivotally mounted with the window operator, a handle rotatably mounted with the mounting and hingedly coupled to the drive element, each of the lever handle and the mounting has a clearance whereby when the handle is rotated to a position where the handle clearance aligns with the mounting clearance, the handle can be hingedly moved relative to the drive element from a first position to a second position, a coupling means couples the mounting to a latch drive member whereby when the handle is moved to the second position the coupling means causes the latch drive to member to move a latching position and when the handle is moved to the first position, the coupling means causes the latch drive member to move to a non-latching position.

Preferably the coupling means is a drive arm pivotally coupled at one end to the mounting and at a second end to a slide element forming or coupled to the latch drive member.

In the preferred form the second end of the drive arm is coupled to the slide element via a drive translation device.

The drive translation device can be a pin slidingly located in an elongate slot situated at an incline relative to a longitudinal axis of the drive element.

Preferably the coupling means is a plurality of teeth coupled to the mounting, said plurality of teeth meshing with a toothed quadrant coupled to a link which is coupled to the latch drive member. The link can be coupled to the latch drive arm via a toggle link arm in an over-centre geometry.

In another form the coupling means is a plurality of teeth coupled to the mounting, said plurality of teeth meshing with a toothed rack coupled to the latch drive member.

### BRIEF DESCRIPTION OF THE DRAWINGS

In the following more detailed description of the invention according to preferred embodiments, reference will be made to the accompanying drawings in which:

FIG. 1 is a plan view of a handle according to a first embodiment of the invention, the handle being shown in the open or unlocked position,

FIG. 2 is a view similar to FIG. 1 but showing the handle in the closed or locked position,

FIG. 3 is a perspective view of the handle and associated shaft of the first embodiment, the handle being shown in a position rotated relative to a bush forming the handle mounting,

FIG. 4 is a view similar to FIG. 3 but showing the handle and bush rotating around the drive shaft,

FIG. 5 is an exploded view of the handle mounting and drive shaft,

FIG. 6 is a plan view of a second embodiment of the invention, the handle being shown in the open position,

FIG. 7 is a view similar to FIG. 6 but with part of the cover and escutcheon removed to show the internal mechanism,

FIG. 8 is a view similar to FIG. 7 but with the handle in the closed and pre-toggle position,

FIG. 9 is a view similar to FIG. 6 but with the handle in the closed and toggled position,

FIG. 10 is a view similar to FIG. 9 but with the escutcheon and part of the cover of the mechanism removed,

FIG. 11 is a perspective view of the handle mounting and drive shaft of the second embodiment,

FIG. 12 is a view similar to FIG. 11 but showing the components in exploded view,

FIG. 13 is yet a further similar view but showing the relationship of the components as the handle is moved toward its closed position relative to the drive shaft,

FIGS. 14-16 are views of the second embodiment of the handle in relation to the arm drive mechanism and the various states between closed and toggled and open,

FIG. 17 is an assembled view similar to FIG. 13 but showing the handle in the open position and rotated relative to the handle mounting,

FIG. 18 is a further illustration of the second embodiment of the handle and associated drive link, and

FIG. 19 is an illustration of a third embodiment of the handle and its associated drive arrangement.

### DETAILED DESCRIPTION OF PREFERRED EMBODIMENTS OF THE INVENTION

The handle according to the present invention is one which performs two functions. The first function is a conventional function with a window operator (winder) where rotation of the handle operates the window operator so that the window operator can drive a window sash between open and closed positions. As will be appreciated by those skilled in the art, many different configurations of window operator are known and are possible whereby a rotating movement of a handle is translated into some other form of movement so as to drive a coupling to a hinged window sash to thereby move the window sash between the open and closed positions.

The construction and configuration of the window operator is not part of the present invention and therefore is not described herein. The present invention is disclosed as having a drive shaft, which can be coupled to a movement translation mechanism to achieve the desired window operator function.

The second function of the handle according to the present invention is to apply a drive to a latching mechanism such as multi-point locking system. This is achieved in a “lever” type action by movement of the handle relative to the drive shaft.

Thus, unlike known window operator and multi-point combinations, the handle drives the opening and closing mechanism of the operator but the handle can then be moved to form a lever to drive (operate) the multi-point mechanism or a lock bolt such as a shoot bolt. Therefore, it is actually the operation of the handle itself, which drives the locking mechanism, shoot bolt or other latching arrangement rather than driving the operator mechanism to achieve the locking/latching action.

It will be appreciated by those skilled in the art that based on this concept different embodiments are possible in order to have the movement of the handle relative to the drive shaft operate the latching arrangement. Examples of suitable mechanisms are disclosed herein.

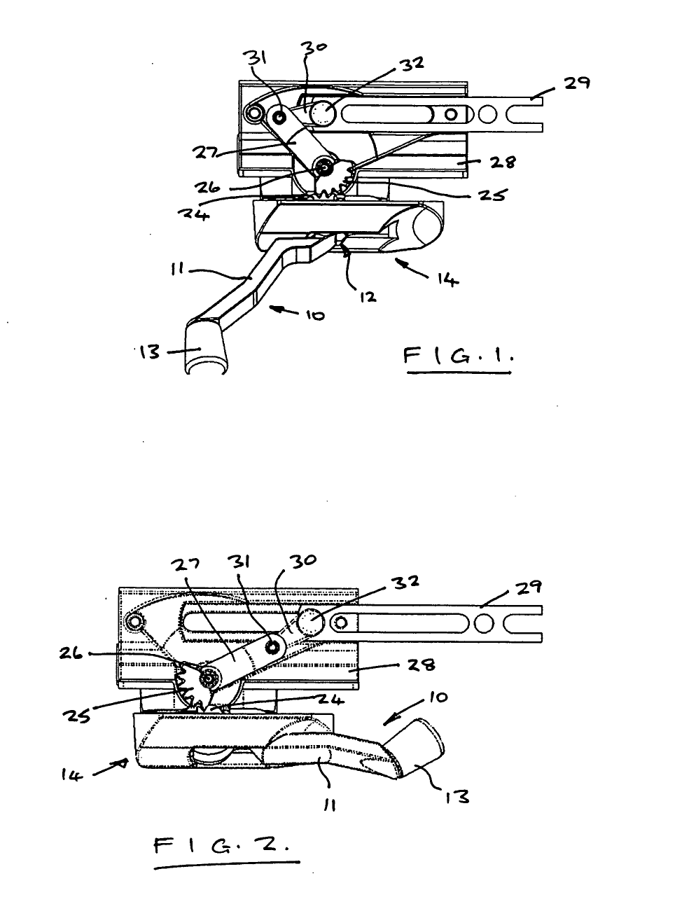

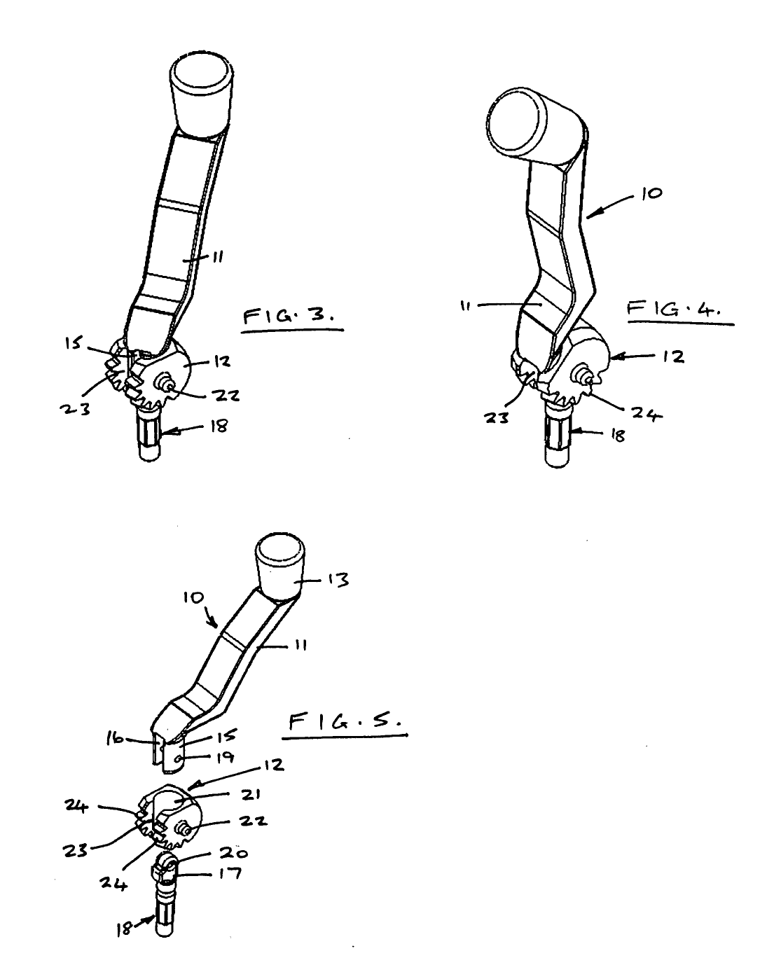

Referring firstly to FIG. 1, there is shown a winder handle 10 which comprises a lever 11, which at one end is mounted with a mounting 12 (see FIG. 3) and at the other end has a winder knob 13 of a conventional construction. The mounting 12 is, in use, mounted in an operator housing, or base 28, which will be normally mounted on or within the window frame.

As can be seen in FIG. 5, the end of the lever arm 11 is formed with or coupled to a spigot mounting 15. The spigot 15 can be bifurcated or as shown in the preferred embodiment is formed with a longitudinal slot 16 which opens through the distal end of the spigot 15. One end 17 of a drive shaft 18 fits into the open end of slot 16 to be pinned therein by a pin (not shown), which, extends through aligned openings 19 of the spigot 15 and opening 20 in the end 17 of the drive shaft 18.

The spigot mount 15 is itself rotatably engaged in a bore 21 in the mounting 12. Extending outwardly from diametrically opposite sides of the mounting 12 are pivot axles or pins 22, which, in use, engage in suitable bearing locations (not shown) in the base 28.

The drive shaft 18 is provided with a profile or coupling/mounting which enables it to engage with and drive the operator mechanism.

As can be seen in FIG. 3, the handle 10 is able to rotate relative to the mounting 12 by virtue of the spigot mount 15 rotating within bore 21. This is when the handle is in the open position as shown in FIG. 1. Thus, the handle 10 can be rotated in a normal manner to achieve operation of the window operator.

In each revolution of the handle, however, there is one point where slot 16 and a gap 23 in the mounting 12 align. In this position, both the handle 10 and mounting 12 are free to rotate about the pivot axis established by pivot pins 22. Consequently, the lever arm 11 can be hingedly, as shown in FIG. 4, to function as a lever to drive a multi-point mechanism, shoot bolt or other latching arrangement. Thus, the handle 10 can be moved to the closed and locked position as shown in FIG. 2.

In the illustrated embodiment, the mounting 12 incorporates teeth 24. These engage with a toothed quadrant 25, which is formed to one side of a pivot axis 26 of a link 27. The link 27 is pivotally mounted with a mounting base 28 as shown in FIGS. I and 2.

One end of a drive bar, bolt or the like 29 is slidingly engaged with the base 28. The link 27 is coupled to the drive bar 29 and does so via a toggle link 30, which is mounted via pivot 31 to link 27 and a pivot 32 to the end of the drive bar 29.

FIG. 1 shows the handle in the open position and able to be rotated relative to the mounting 12 in order to apply the necessary drive to the window operator. When the window sash is in the closed position and the slots 16 and 23 are aligned, the lever handle 11 can then be hinged over towards its closed position. As it does so, the teeth 24 of the mounting 12 engaging with tooth quadrant 25 rotates the link 27 which drives the drive arm 29 to operate the multi-point mechanism.

The toggle link arm 30 provides an over-centre action or toggle action at the completion of the movement of the lever arm 11 into the locked position. This can be seen from FIG. 2. This over-centre action ensures that any force applied to the drive bar 29 by someone endeavouring to make a forced entry through the window from the outside cannot move the handle 10 back to an open position to thereby release the locking mechanism. Consequently, in addition to activation of the locking mechanism, the toggle over of the toggle arm 30 prevents the system from being driven open. It thereby provides protection against forced entry.

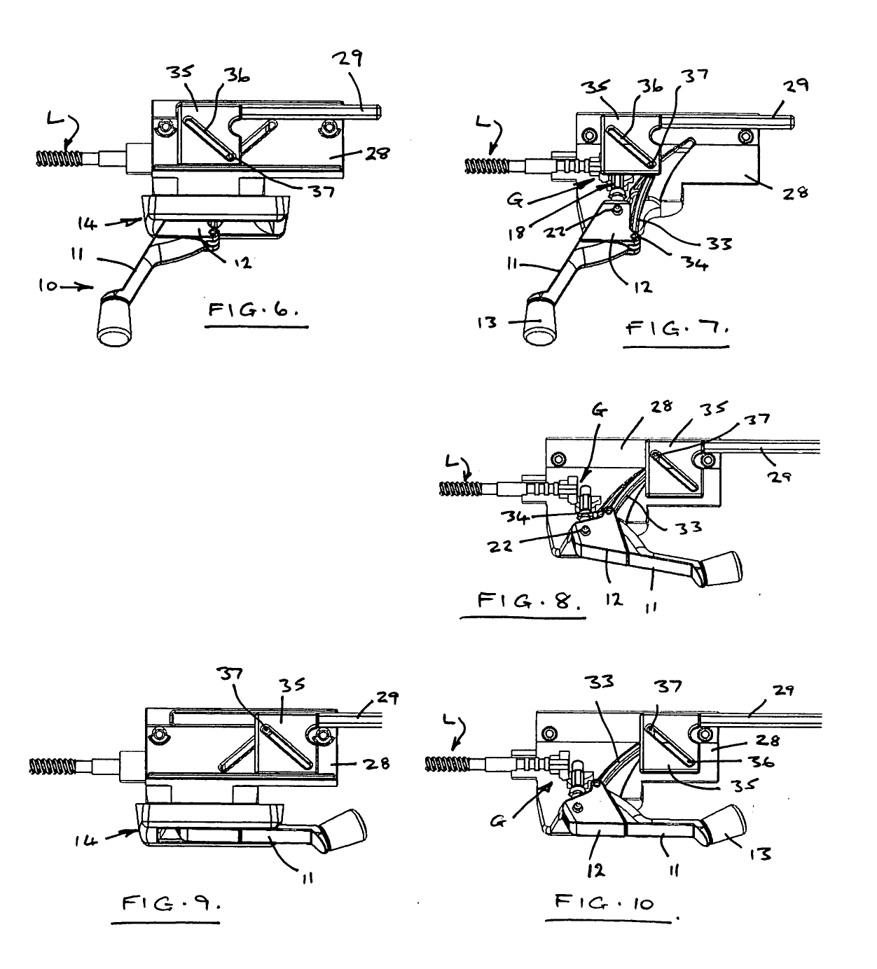

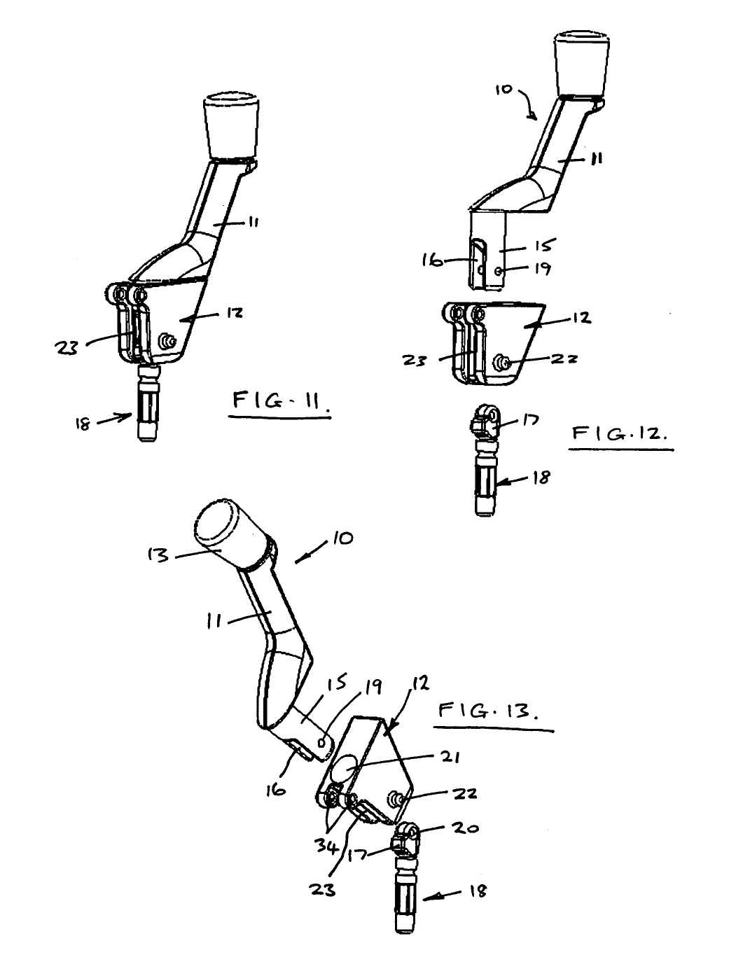

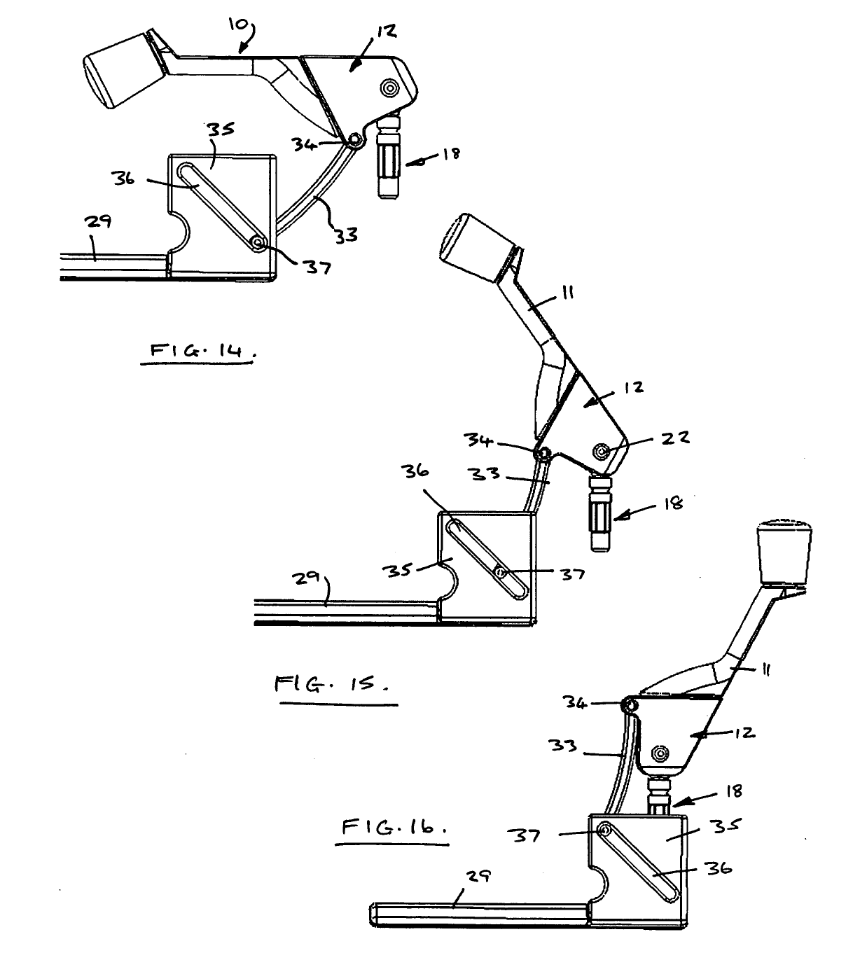

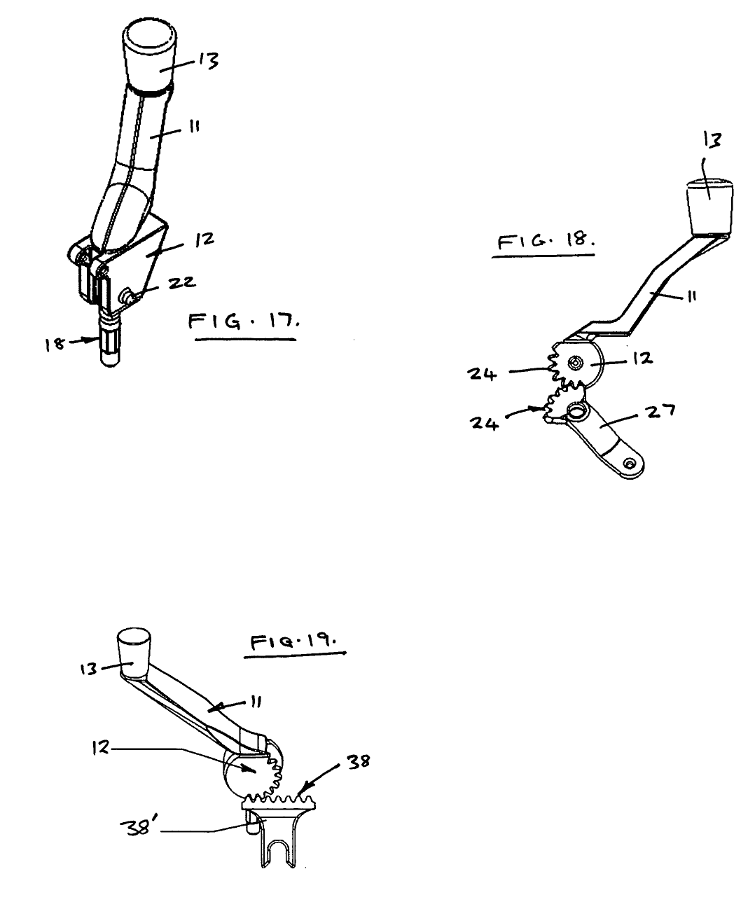

According to the second embodiment of the invention as shown in FIG. 6-17, features which are common with the first embodiment are referred to by the same reference numeral. However, according to this embodiment, the drive coupling between the lever 11 and the drive bar 29 is not via toothed elements. As can be seen in FIGS. 14-16, a drive arm 33 is pivotally coupled via pivot 34 to the mounting 12. The other end of the drive arm 33 is coupled to a slide 35 which is slidingly mounted with the base 28.

An elongate slot 36 is formed in the slide 35 and via a sliding pin or other arrangement 37 engaged in slot 36, the drive arm 33 is linked to the slide 35. The elongate slot 36 is, as shown, at an incline to the axis of rotation of drive shaft 18. Thus, the sliding pivot 37 and slot 36 form a drive translation device whereby hinged movement of the lever handle 11 and mounting 12 is translated into a sliding movement of slide 35.

The slide 35 forms part of or is coupled directly to the drive bar 29 of the locking mechanism. Accordingly, as shown in FIGS. 6 and 7 with the lever 11 in the open position, the lever can be moved to a closed but pre-toggled position as shown in FIG. 8. This movement of the lever is translated via drive arm 33 to a sliding movement of coupling 37 in the elongate 36 and hence to a sliding movement of the slide 35 with associated movement of drive bar 29.

Further movement of the arm 33 into the fully closed and toggled position as shown in FIGS. 9 and 10 creates an overcentre action, which locks the slide 35 against movement in the event that an attempt is made at forced entry by applying a reverse force on the drive bar 29.

As mentioned previously, other embodiments of the invention are possible as will be appreciated by those skilled in the art. Such an alternative arrangement is shown in FIG. 19 where the mounting 12 with gear teeth 24 drive a rack 38. The rack can be used to directly drive, via e.g. coupling 38′, a multi-point drive bar or can be linked to the drive bar by a lever. The lever can be used to amplify the motion.

According to another alternative, the drive 33 can, rather than being solid as illustrated, be of a flexible spring material and can be linked either to the multi-point drive bar directly or via a motion amplification mechanism as shown in the second embodiment.

The lever handle according to the present invention therefore has a mounting which enables the handle to be rotated about an axis of rotation, providing not only the ability of the lever handle to be moved to a parking or closed position but also to drive a locking device. Consequently, only one handle is required for both window operation and locking. Thus, folding the handle into a closed or park position the locking mechanism is automatically operated. An advantage of this arrangement is that only one route through the window frame is required for both window operation and locking.

What is claimed is:

1. A handle for a window operator, the handle including a lever handle, a mounting to which the lever handle is rotatably coupled, the mounting being mountable about a pivot is, a drive element to which the lever handle is hingedly coupled, each of the lever handle and the mounting having a clearance such that the lever handle can be rotated to a position relative to the mounting where the
lever handle clearance aligns with the clearance of the mounting to thereby permit the mounting and lever handle to pivotally move relative to the drive element, the mounting including coupling means for the coupling of a part of a latching mechanism such that said part of the latching mechanism is movable in response to the pivotal movement of the lever handle and mounting.

2. A handle as claimed in claim 1 wherein the lever handle has a spigot mount and the mounting has a bore into which the spigot mount is rotatably located.

3. A handle as claimed in claim 2 wherein the lever handle clearance is formed by a longitudinally extending bore in the spigot mount, the slot opening through a distal end of the spigot mount and through which an end of the drive element extends into the slot.

4. A handle as claimed in claim 3 wherein the end of the drive element is pivotally coupled to the spigot mount inwardly of the distal end of the spigot mount.

5. A handle as claimed in claim 3 or 4 wherein the clearance in the mounting is a gap formed in a part of the mounting.

6. A handle as claimed in claim 4 wherein the clearance in the mounting is a gap formed in the mounting and the mounting includes a pair of oppositely disposed outwardly projecting pivot elements.

7. A handle as claimed in claim 6 wherein the coupling means of the mounting includes a plurality of teeth.

8. A handle as claimed in claim 6 wherein the coupling means of the mounting includes at least one pivot mount.

9. A window operator including a drive mechanism, which, in use, is operable to use a window sash to move between open and closed positions, a drive element coupled to the drive mechanism, a mounting pivotally mounted with the window operator, a handle rotatably mounted with the mounting and hingedly coupled to the drive element, each of the lever handle and the mounting has a clearance whereby when the handle is rotated to a position relative to the mounting where the
handle clearance aligns with the mounting clearance, the handle can be hingedly moved relative to the drive element from a first position to a second position, a coupling means couples the mounting to a latch drive member whereby when the handle is moved to the second position the coupling means causes the latch drive to member to move a latching position and when the handle is moved from the second position to the first position, the coupling means causes the latch drive member to move to a non-latching position.

10. A window operator as claimed in claim 9 wherein the coupling means is a drive arm pivotally coupled at one end to the mounting and at a second end to a slide element forming or coupled to the latch drive member.

11. A window operator as claimed in claim 10 wherein the second end of the drive arm is coupled to the slide element via a drive translation device.

12. A window operator as claimed in claim 11 wherein the drive translation device is a pin slidingly located in an elongate slot situated at an incline relative to a longitudinal is of the drive element.

13. A window operator as claimed in claim 9 wherein the coupling means is a plurality of teeth coupled to the mounting, said plurality of teeth meshing with a toothed quadrant coupled to a link which is coupled to the latch drive member.

14. A window operator as claimed in claim 13 wherein the link is coupled to the latch drive arm via a toggle link arm in an over-centre geometry.

15. A window operator as claimed in claim 9 wherein the coupling means is a plurality of teeth coupled to the mounting, said plurality of teeth meshing with a toothed rack coupled to the latch 20 drive member.

16. A window operator as claimed in claim 10 or 11 wherein the lever handle has a spigot mount and the mounting has a bore which the spigot mount is rotatably located.

17. A window operator as claimed in claim 16 wherein the lever handle clearance is formed by a longitudinally extending bore in the spigot mount, the slot opening through a distal end of the spigot mount and through which an end of the drive element extends into the slot.

18. A window operator as claimed in claim 17 wherein the end of the drive element is pivotally coupled to the spigot mount inwardly of the distal end of the spigot mount.

19. A window operator as claimed in claim 17 wherein the clearance in the mounting is a gap formed in a part of the mounting.

20. A window operator as claimed in claim 17 wherein the clearance in the mounting is a gap formed in a part of the mounting and the mounting includes a pair of oppositely disposed outwardly projecting pivot elements.

21. A window operator as claimed in claim 19 wherein the coupling means of the mounting includes a plurality of teeth.

22. A handle as claimed in claim 19 wherein the coupling means of the mounting includes at least one pivot mount.
